(19) United States
(12) Patent Application Publication
(10) Pub. No.: US 2015/0201113 A1
(43) Pub. Date: Jul. 16, 2015

(54) Handheld Camera Balancing Apparatus

(71) Applicant: Dennis Wood, Thunder Bay (CA)

(72) Inventor: Dennis Wood, Thunder Bay (CA)

(21) Appl. No.: 14/178,811

(22) Filed: Feb. 12, 2014

Related U.S. Application Data
(60) Provisional application No. 61/764,207, filed on Feb. 13, 2013.

(51) Int. Cl. H04N 5/225; G03B 17/56

(52) U.S. Cl. CPC H04N 5/2253; G03B 17/561

(57) ABSTRACT

A balancing apparatus is suited for use with a camera enabled device such as a smart phone to assist in stabilizing the video being captured. A camera mount including adjustable stabilizer weights balances the camera enabled device on grip member using a pivot coupling. The grip member compactly grips about a single finger of the user. The stabilizer weights are adjustably positioned about multiple axes for optimal counterbalancing and for providing an adjustable stand for being self-supported on a variety of supporting surface configurations. The stabilizer weights are carried by adjustable arms in which both the weights and arms can be pivoted into a storage position alongside a main body portion of the camera mount within a perimeter boundary of the camera mount and smart phone received therein.

This application claims the benefit under 35 U.S.C.119(e) of U.S. provisional application Serial No. 61/764,207, filed Feb. 13, 2013.

### FIELD OF THE INVENTION

The present invention relates to a balancing apparatus arranged to support a handheld camera enabled device thereon such that the camera enabled device is balanced on a balance point of the apparatus so as to steady motion of a camera operator displacing the camera enabled device through an environment being captured on video by the camera enabled device.

### BACKGROUND

In recent years the quality of cameras on small hand-held electronic devices has improved considerably such that it is now common to capture quality video on point and shoot cameras, smart phones, and the like in addition to camcorders and other dedicated video capturing devices. When capturing video on a camera while moving through a scene, it is desirable to support the camera on a device which steadies the motion of the camera, typically by counterbalancing the camera on a substantially free pivot. Known designs however are typically only well suited for larger cameras having a considerable mass relative to small hand-held electronic devices which are now enabled with cameras.

U.S. Pat. No. 7,563,038 by Hershenzon discloses a support for a camcorder in which the camcorder is counterbalanced with a stabilizer arm on a free pivot which comprises a ball received within a socket. The large contact area between the ball and surrounding socket results in sufficient friction that minor movements of the operator grasping a handle of the ball can be readily transmitted through the socket to the camera.

U.S. Pat. Nos. 7,255,499 by Schaller and 5,742,859 by Acker disclose further examples of camera balance devices relying on a universal joint comprised of bearings and multiple pivoting parts to allow substantially free pivotal movement of the camera and stabilizer weight relative to the operator supported handle. The complexity of the pivot joints in each instance also results in a sufficient contact area of relative moving parts that the small amount of friction can transmit small vibrating movements from the user to the camera through the pivotal connection when using small hand-held electronic devices. The problem of small user movements being transmitted through the pivot is typically not of concern when using a larger camera as the mass of the camera in the prior art functions to dampen the movement transmitted through the joint.

Furthermore, in each instance in the prior art, steering of the camera typically requires contacting a portion of the support device which is in fixed connection to the camera such that small user vibrations in steering the direction of the camera can be readily transmitted to the video being captured. When using larger cameras in the prior art, the mass of the camera also typically dampens the vibration of a steering movement by the operator; however, the prior art devices are unsuitable for the light weight hand-held electronic devices now enabled with cameras.

In general, prior art devices are not well suited to being compact and carried with portable electronics such as smartphones which are increasingly being used in place of digital video and point and shoot cameras. Accordingly the prior art devices for stabilizing moving video cameras, or conventional stands such as tripods and the like, are not suited to the small portable nature of portable electronics enabled with cameras such as smartphones and the like.

### SUMMARY OF THE INVENTION

According to one aspect of the invention there is provided a balancing apparatus for a handheld camera device comprising:
a camera mount arranged to support the handheld camera device in fixed relation thereon;
a first pivot coupling supported on the camera mount such that the camera mount is arranged to support the handheld camera device substantially above the first pivot coupling;
at least one stabilizer arm extending between a first end coupled to the camera mount and a second end supporting a stabilizing weight thereon below the first pivot coupling; and
a grip member comprising a grip portion arranged to be gripped by a user and a second pivot coupling supported on the grip portion;
the second pivot coupling being arranged to be coupled to the first pivot coupling for pivotal movement relative to one another about a balance point between the first and second pivot couplings such that the stabilizing weight of said at least one stabilizer arm is arranged to be balanced below the balance point with the camera mount above the balance point when a handheld camera device is supported on the camera mount; and
the grip portion of the grip member comprising a finger grip arranged to be gripped in a self-supporting manner about at least one finger of a user such that the balancing apparatus is arranged to be carried solely on said at least one finger of the user.

The grip portion which can be readily arranged to be gripped on a single finger of the user is thus very compact in nature and very well suited for use with small portable electronic equipment being used for capturing digital video.

Preferably the finger grip comprises a C-shaped member arranged to extend generally circumferentially about a single finger of the user in which the C-shaped member is formed of resilient material arranged to resilient grip said single finger of the user therein.

In preferred embodiments, one of the first and second pivot couplings comprises a socket body locating a socket therein having an inner surface which tapers radially inwardly and axially inwardly towards a central apex of the socket, and the other one of the first and second pivot couplings comprises:
a tip portion projecting axially outwardly and tapering radially inwardly towards a central apex which is pointed and which is engaged with the central apex of the socket at the balance point so as to be arranged for pivotal movement relative to one another; and
a shroud portion in fixed relation to the tip portion which at least partially surrounds the socket body.

Preferably the shroud portion is in non-contacting relationship with the socket body when the central apex of the tip portion is engaged with the central apex of the socket and the camera mount is balanced above the balance point with the stabilizing weight of said at least one stabilizer arm below the balance point. Preferably the shroud portion includes a retainer portion arranged to retain the socket body within the shroud portion such that the central apex of the tip portion remains engaged with the central apex of the socket in a working position.

Preferably the retainer portion is resiliently deformable from the working position to a release position in which the socket body is readily removable from the shroud portion

In the illustrated embodiment, the shroud portion comprises plastic material which is integrally formed with the camera mount while the central apex of the tip portion is formed of metal and is mounted in fixed relation to the camera mount with the shroud portion. Similarly, the central apex of the socket may be formed of metal and may be mounted in fixed relation with the remainder of the grip member which is formed of plastic material.

The camera mount preferably comprises a smartphone case arranged to receive a video camera enabled smartphone therein in which the first pivot coupling is integrally formed on the smartphone case.

The camera mount may further comprise: I) a rear backing member arranged to span a rear side of a smartphone therein; ii) a camera aperture in the rear backing member arranged to align with a camera of the smartphone; and iii) a light shield member arranged to protrude rearwardly from the rear backing member above the camera aperture in a working position so as to provide the function of a matte box for blocking undesirable light directed across the lens of the camera.

Preferably the stabilizing weight of said at least one stabilizer arm is supported by a first mounting portion so as to be adjustable in a lateral direction relative to the camera mount and by a second mounting portion so as to be adjustable in the forward direction relative to the camera mount. More particularly, the stabilizer weight of said at least one stabilizer arm may be supported by the first mounting portion for pivotal movement relative to the camera mount about a first axis oriented in a forward direction of the handheld camera device and by the second mounting portion for pivotal movement relative to the camera mount about a second axis oriented in the lateral direction of the handheld camera device.

Preferably both the first axis and the second axis are located in proximity to the second end of the stabilizer arm.

Preferably each stabilizer arm is also pivotal relative to the camera mount about an auxiliary axis which is located at the first end of the stabilizer arm and which is substantially parallel with the first axis.

Preferably there is provided two stabilizer arms coupled to the camera mount at laterally spaced positions, each for respective movement between a stored position in which the stabilizing weights and stabilizer arms are supported in a generally common plane with one another adjacent the camera mount and at least one working portion in which the stabilizing weight is spaced below the camera mount at a predefined position. The fine adjustment of the stabilizing weights relative to the camera mount are thus performed about the first and second axes at the second end of the stabilizer arms instead of at the auxiliary axes at the first ends of the stabilizer arms.

When there are two stabilizer arms arranged to be coupled to the camera mount in a working position, preferably each stabilizer arm further supports two stabilizer weights thereon such that each stabilizer weight is adjustable both in a lateral direction relative to the camera mount and in the forward direction relative to the camera mount.

Each of the four stabilizer weights may further comprise a footing supported thereon so as to be readily interchangeable with another footing of different configuration. In this instance, the camera mount is well suited to be self-supported in an upright orientation on a generally horizontal supporting surface when only the footings are engaged with the supporting surface. The footing may be different in configuration by having different weight for balancing, different size for balancing or may include auxiliary features such as rollers or wheels for rolling movement along a supporting surface when the camera mount is supported in a self-supported manner for example.

According to a second aspect of the present invention there is provided a balancing apparatus for a handheld camera device comprising:
a camera mount arranged to support the handheld camera device in fixed relation thereon;
a first pivot coupling supported on the camera mount such that the camera mount is arranged to support the handheld camera device substantially above the first pivot coupling;
at least one stabilizer arm extending between a first end coupled to the camera mount and a second end supporting a stabilizing weight thereon below the first pivot coupling; and
a grip member comprising a grip portion arranged to be gripped by a user and a second pivot coupling supported on the grip portion;
wherein the second pivot coupling is arranged to be coupled to the first pivot coupling for pivotal movement relative to one another about a balance point between the first and second pivot couplings such that the stabilizing weight of said at least one stabilizer arm is arranged to be balanced below the balance point with the camera mount above the balance point when a handheld camera device is supported on the camera mount;
wherein one of the first and second pivot couplings comprises a socket body locating a socket therein having an inner surface which tapers radially inwardly and axially inwardly towards a central apex of the socket; and
wherein the other one of the first and second pivot couplings comprises:
   a tip portion projecting axially outwardly and tapering radially inwardly towards a central apex which is pointed and which is engaged with the central apex of the socket at the balance point so as to be arranged for pivotal movement relative to one another; and
   a shroud portion in fixed relation to the tip portion which at least partially surrounds the socket body.

Preferably the shroud portion is in non-contacting relationship with the socket body when the central apex of the tip portion is engaged with the central apex of the socket and the camera mount is balanced above the balance point with the stabilizing weight of said at least one stabilizer arm below the balance point. Furthermore, preferably the shroud portion includes a retainer portion arranged to resiliently retain the socket body within the shroud portion such that the central apex of the tip portion remains engaged with the central apex of the socket in a working position.

In this manner, the shroud acts to assist in retaining the first and second pivot couplings together in use, while being configured in a non-contacting relationship so that there is no frictional resistance introduced to the movement between the first and second pivot couplings. This ensures optimal performance in isolated undesirable movements of the grip portion in being translated to the camera mount and camera device supported thereon.

In some embodiments the stabilizer arms are pivotally coupled at the first end thereof to the main portion so as to be movable between a working portion in which the stabilizing weight of said at least one stabilizer arm is spaced below the camera mount and a stored position in which: i) the stabilizer arms and the respective stabilizing weights are supported alongside the common plane of the main portion of the camera mount; and ii) the stabilizer arms and the respective stabilizing weights are mostly contained within a perimeter boundary of the main portion of the smartphone case. The compact folding configuration of the stabilizer arms and stabilizing weights which fold into the perimeter boundary of the smartphone case provides a sufficiently compact storage position that the balancing apparatus can remain attached to the smartphone even when not in a balancing mode without being too cumbersome for other uses of the smartphone. The balancing apparatus can thus remain ready for use at all times without affecting normal function of the smartphone when not in use.

In some instance, steering is provided by i) a first magnetic coupling member on the camera mount, and ii) a steering member separate from the camera mount which includes a grip portion arranged to be gripped by a user and a second magnetic coupling member supported on the grip portion. In this instance the first and second magnetic coupling members are arranged to interact magnetically with one another such that a non-contacting steering movement of the steering member relative to the grip member is arranged to controllably induce a steering movement of the camera mount relative to the grip member.

In some embodiments the steering system may further include a pair of auxiliary magnetic members supported on the camera mount at laterally opposing sides of the first magnetic coupling member, the auxiliary magnetic members being arranged to be magnetically repelled by the second magnetic coupling member such that the second magnetic coupling member is arranged to remain substantially laterally balanced between the pair of auxiliary magnetic members at a location spaced outwardly from the upright steering axis during said non-contacting steering movement.

According to one embodiment the grip portion of the steering member preferably also comprises a finger grip arranged to be gripped generally circumferentially about a single finger of the user. Alternatively, the second magnetic coupling member may be supported on the grip member at a location spaced radially outwardly from the upright steering axis of the pivot couplings.

According to a third aspect of the present invention there is provided a balancing apparatus for use with a smartphone including a rear backing plate and a video camera, the apparatus comprising:
a camera mount arranged to support the handheld camera device in fixed relation thereon;
a first pivot coupling supported on the camera mount such that the camera mount is arranged to support the handheld camera device substantially above the first pivot coupling;
at least one stabilizer arm extending between a first end coupled to the camera mount and a second end supporting a stabilizing weight thereon below the first pivot coupling; and
a grip member comprising a grip portion arranged to be gripped by a user and a second pivot coupling supported on the grip portion;
the second pivot coupling being arranged to be coupled to the first pivot coupling for pivotal movement relative to one another about a balance point between the first and second pivot couplings such that the stabilizing weight of said at least one stabilizer arm is arranged to be balanced below the balance point with the camera mount above the balance point when a handheld camera device is supported on the camera mount;
wherein the stabilizing weight of said at least one stabilizer arm is supported by a first mounting portion so as to be adjustable in a lateral direction relative to the camera mount and by a second mounting portion so as to be adjustable in the forward direction relative to the camera mount.

The dual adjustment of the stabilizing weights relative to the camera mount permits the stabilizing weights to provide a dual function of i) adjustable counter-balancing in a balancing mode of operation, and ii) adjustable footings in a self-supporting standing mode of operation on various supporting surface configurations.

According to another aspect of the present invention there is provided a balancing support system for a handheld camera device comprising:
a camera mount arranged to support the handheld camera device in fixed relation thereon;
a first pivot coupling supporting the camera mount thereabove;
a grip member comprising a grip portion arranged to be gripped in a hand of a user and a second pivot coupling fixed relative to the grip portion; and
two stabilizer arms, each stabilizer arm extending between a first end coupled to the camera mount and a second end supporting a respective stabilizing weight thereon below the first pivot coupling on the support body such that the stabilizer weights are spaced apart in a lateral direction at opposing sides of the camera mount;
the first and second pivot couplings being arranged to be coupled for pivotal movement relative to one another about a balance point between the first and second pivot couplings such that the stabilizing weights of the stabilizer arms supported below the balance point are balanced about the balance point with the handheld camera device arranged to be supported by the camera mount above the balance point; and
the stabilizer weights and the stabilizer arms being arranged to support the camera mount such that the camera mount is self-supported in an upright orientation on the stabilizer arms when only the stabilizer weights are engaged upon a horizontal supporting surface.

According to yet another aspect of the present invention there is provided a balancing support system for a handheld camera device comprising:
a camera mount arranged to support the handheld camera device in fixed relation thereon;
a first pivot coupling supporting the camera mount thereabove;
a grip member comprising a grip portion arranged to be gripped in a hand of a user and a second pivot coupling fixed relative to the grip portion; and
at least one stabilizer arm extending between a first end coupled to the support body and a second end supporting a stabilizing weight thereon below the first pivot coupling on the support body;
the first and second pivot couplings being arranged to be coupled for pivotal movement relative to one another about a balance point between the first and second pivot couplings such that the stabilizing weight of said at least one stabilizer arm supported below the balance point is balanced about the balance point with the handheld camera device arranged to be supported by the camera mount above the balance point;
a steering member separate from the camera mount, the steering member including a grip portion arranged to be gripped in a hand of user;
a first magnetic coupling member on the camera mount; and
a second magnetic coupling member on the steering member;
the first and second magnetic coupling members being arranged to interact magnetically with one another while remaining spaced apart such that a non-contacting steering movement of the steering member relative to the grip member is arranged to controllably induce a steering movement of the camera mount relative to the handle member without contact between the first and second magnetic coupling members.

Various embodiments of the invention will now be described in conjunction with the accompanying drawings in which:

### BRIEF DESCRIPTION OF THE DRAWINGS

FIG. 1 is a perspective view of a front side a first embodiment of the balancing apparatus in a working position;

FIG. 2 is perspective view of a rear side of the balancing apparatus in the working position according to the first embodiment;

FIG. 3 is a side elevational view of the balancing apparatus in the working position according to the first embodiment;

FIG. 4 is a rear elevational view of the balancing apparatus in the working position according to the first embodiment;

FIG. 5 is a perspective view of the rear side of the balancing apparatus in a stored position according to the first embodiment;

FIG. 6 is a rear elevational view of the balancing apparatus in the stored position according to the first embodiment;

FIG. 7 is a sectional view along a vertical axis of the first and second pivot couplings of the balancing apparatus according to the first embodiment;

FIG. 8 is a perspective of a bottom side of the first pivot coupling shown with the second pivot coupling separated therefrom according to the first embodiment;

FIG. 9 is a perspective view of a rear side of a second embodiment of the balancing apparatus shown in the working position;

FIG. 10 is a perspective view of a front side of the balancing apparatus shown in the working position according to the second embodiment;

FIG. 11 is a rear elevational view of the balancing apparatus in the working position according to the second embodiment;

FIG. 12 is a side elevational view of the balancing apparatus in the working position according to the second embodiment; and

FIG. 13 is a perspective view of a pivot shaft including alignment features for positioning the stabilizer arm in a predefined working position according to the second embodiment.

In the drawings like characters of reference indicate corresponding parts in the different figures.

### DETAILED DESCRIPTION

Referring to the accompanying figures, there is illustrated a camera balancing apparatus generally indicated by reference numeral 10. The apparatus 10 is particularly suited for use with a portable handheld camera device of the type which is enabled with a video camera for capturing video. Examples of typical electronic devices which may be used with the apparatus or a variant thereof include point and shoot digital cameras, smart phones and the like.

Although various embodiments shown in the accompanying figures, the common features of the various embodiments will first be described.

In the illustrated embodiments, the apparatus is particularly suited for use with a smart phone of the type having a flat rectangular body including a rear backing plate spanning a rear side of the phone opposite a front display surface spanning the front side of the phone. A camera may be provided on both sides, but preferably at least on the rear surface for capturing video in a working direction of the lens for simultaneous display on the opposing front surface of the phone. One example is the Apple™ iPhone™. Another smart phone simple for use with the apparatus with minor modifications to the illustrated embodiment include the Samsung™ Galaxy™.

The apparatus 10 generally includes a camera mount 20 for attachment to the smart phone. The camera mount 20 is generally in the form of a smart phone case for gripping and surrounding the phone housing without interfering with the normal use of the phone. Accordingly, the front display surface of the phone remains substantially unobstructed while most of the peripheral edge of the phone also remains unobstructed.

The camera mount 20 includes a main body portion 22 which is generally rectangular and spans in a generally flat common plane fully across the rear side of the smart phone between a top edge 24, a bottom edge 26 and two side edges 28 which are spaced apart in a lateral direction for alignment with corresponding edges of the phone when the phone is held in an upright orientation for capturing video. The top edge, the bottom edge and the two side edges 28 define a generally rectangular perimeter boundary of the main body portion of the camera mount.

The camera mount further includes a plurality of camera gripping portions 30 which project forwardly from an inner surface of the main body portion 22 for extending over respective edges of the smart phone. The gripping portions are located at the four corners and at a central intermediate location along each of the top and bottom edges respectively. Each gripping portion projects commonly in the forward direction to a respective free end locating a retainer edge 32 thereon which extends inwardly for hooking over the front display surface of the smart phone housing such that the smart phone is retained flat against the main body portion 22 of the camera mount. The camera gripping portions are located at corresponding locations which do not interfere with the button access along the peripheral edges of the smart phone housing.

The camera mount further includes a camera aperture 34 in the main body portion 22 adjacent a top corner for alignment with a corresponding camera lens on the rear side of the smart phone received within the camera mount.

The camera mount further includes a microphone channel 36 integrally molded into one of the side edges of the main body portion in the form of a curved directional member communicating between an inner end aligned with a microphone in the corresponding edge of the smart phone and an outer open end which faces in the working direction of the camera. In this manner, the first channel is suitably oriented for re-directing sound emanating for an object being captured by the video camera towards the microphone at the side edge of the smart phone housing.

Similarly, a speaker channel 38 is also integrally formed with the side edge of the main body portion of the camera mount in the form of a curved directional surface communicating between an inner end aligned with the speaker and an open outer end directed to face forwardly in relation to the forward display face of the smart phone housing opposite from the working direction of the camera. In this manner, sound emanating from the speaker of the smart phone is directed towards a user observing the front display surface of the smart phone.

The apparatus 10 includes two stabilizer arms 40 which are pivotally coupled to the camera mount for balancing the smart phone supported on the camera mount as described in further detail below. For supporting the stabilizer arm, the camera mount includes two pivot shafts 42 integrally molded thereon in which the two pivot shafts are located adjacent the two bottom corners of the main body portion at the bottom side of the camera mount at laterally opposed ends. The pivot shafts define respective pivot axes which extend in the working direction of the camera perpendicular to the common plane of the main body portion and opposite from the camera gripping portions of the camera mount.

The two stabilizer arms 40 are pivotally mounted at respective first ends on the two pivot shafts 42 to extend towards opposing second ends which are moveable in an arcuate path following the pivotal movement of the arms between a working position in which the two second ends are spaced apart wider than the camera mount at a location spaced below the camera mount and a stored position in which the two stabilizer arms extend alongside the common plane of the main body portion so as to be fully contained within the perimeter boundary defined by the edges of the main body portion. Typically features are provided on the pivot shaft so that the working position is a predetermined position corresponding to the stabilizer arms being aligned in a predetermined orientation so as to be laterally balanced with one another relative to a balance point of the balancing apparatus.

Each stabilizer arm 40 supports two stabilizer legs 44 at the second end thereof in which each leg defines a respective stabilizer weight which is adjustably located relative to the camera mount. The two legs of each stabilizer arm are supported on the respective arm by a pivot link 46 or knuckle which is pivotally coupled to the second end of the respective arm about a respective first axis which is parallel to the pivot axes of the pivot shafts 42 so as to be oriented in the forward working direction of the lens of the camera.

Stops 47 are integrally molded onto the pivot links 46 for engaging corresponding portions of the respective stabilizer arms in a fully deployed working position of the legs relative to the stabilizer arms. By pivoting the legs relative to the arms from the storage position towards the working position until the stops 47 prevent further relative pivoting beyond the working position, the legs are also positioned in a predetermined and laterally balanced condition relative to the balance point of the balancing apparatus. The legs can be subsequently independently pivoted inwardly towards one another from the working position as required to counterbalance an off-center smartphone supported on the camera mount.

The two legs 44 are also pivotable on the respective pivot link 46 for independent pivotal movement about a common second axis relative to the pivot link, the stabilizer arm, and the camera mount respectively. The second axis is oriented perpendicularly to the first axis. In the working position, the legs extend generally downwardly from the respective second ends of the respective stabilizer arms so that the second axes are oriented generally in a lateral direction. In this instance, the lateral position of the stabilizer weights defined by the legs 44 can be readily adjusted by pivotal movement of the links 46 relative to the stabilizer arms about the respective first axes oriented in the working direction of the camera. Alternatively, the position of the stabilizer weights defined by the support legs 44 can be adjusted in the working direction of the camera to vary its distance from either side of the common plane of the main body portion of the camera mount by pivoting each leg independently about its respective second axis relative to the pivot link which is supported on the stabilizer arm, which is in turn supported on the camera mount.

The two support legs of each stabilizer arm are arranged to fold flat against one another in a stored position such that the combined thickness of each pair of legs in the working direction of the camera lens is approximately equal to the thickness of the respective stabilizer arm. The pivot link 46 provides a radial offset of the legs relative to the respective first axes so as to permit the two legs folded against one another to be in turn folded alongside the respective stabilizer arm in parallel relation thereto. The legs 44 thus lie generally in a common plane with the stabilizer arms alongside the common plane of the main body portion of the camera mount while being substantially fully contained within the perimeter boundary defined by the main body portion of the camera mount.

The stabilizer legs 44 have a dual function of providing a self-supporting standing structure for supporting a camera on the camera mount on a horizontal supporting surface or a large variety in counters to such a supporting surface, while also providing a stabilizing function when balancing the camera mount on a handheld grip member as described in further detail below. The bottom ends of the legs define respective footings 48.

When the footings of the four support legs are engaged with a corresponding supporting surface, the camera is supported in a very stable configuration by being generally centered in both a lateral direction and in a forward working direction of the camera lens relative to the footings which provide the sole engagement of the balancing apparatus with the supporting surface.

Alternatively, in a balancing mode of operation, the legs 44 provide the function of stabilizer weights which provide a counterbalancing below a balance point of the balance assembly relative to a phone supported on the camera mount above the balance point of the balance assembly. The balance assembly is typically provided at the bottom side edge of the camera mount so that the smart phone is supported fully above the balance assembly while the stabilizer weights supported at the second ends of the stabilizer arms are able to be positioned spaced below the balance point.

The various adjustments of the legs about the various axes described above thus provides the dual function of both positioning the footings in various orientations relative to one another for being engaged upon varying contours of supporting surfaces with the camera mount supporting a phone thereon in a self supporting manner solely using the footings, as well as varying the balance configuration of the stabilizer weights relative to a smart phone supported in the camera mount. For example, the stabilizer weights can be shifted forwardly or rearwardly to support the smart phone tilted upwardly or downwardly in a balance configuration.

The balance assembly generally includes a first pivot coupling 50 fixed centrally on the bottom side of the camera mount and a second pivot coupling 52 which forms part of a separate grip member 54 upon which the camera mount is supported in the balanced mode of operation. The first and second pivot couplings are arranged to be coupled to one another for pivotal movement relative to one another about a balance point between the first and second pivot couplings such that the stabilizing weight of the stabilizing arms are arranged to be balanced below the balance point with the smart phone supported on the camera mount above the balance point.

The first pivot coupling 50 is defined by a tip portion having a conical surface 56 which is symmetrical about a central upright axis of the pivot couplings such that the conical surface projects axially outward while tapering radially inward to a single point central apex of the tip portion. The conical surface extends downwardly from the bottom side of the camera mount towards the central apex which forms a pointed bottom end of the tip portion.

The tip portion 55 is surrounded by a shroud portion 58 which has a generally spherical inner surface centered at the central apex of the tip portion at a location spaced radially outward therefrom. The bottom end of the shroud portion includes a central bottom aperture 60 arranged to receive the second pivot coupling therethrough. The conical surface has a sharp pointed central apex of less than 45 degrees such that the conical surface itself is near 15 degrees from vertical for example.

The second pivot coupling comprises a socket body 62 having a generally spherical outer surface 64 with a diameter which is slightly less than the spherical inner surface of the shroud portion. A socket 66 is formed in the top end of the socket body in which the inner surface of the socket is conical in shape about the vertical axis of the pivot assembly so that the inner surface of the socket tapers radially inwardly as it extends axially inwardly towards a central pointed apex at the inner end of the socket. Diametrically opposed portions of the conical surface meet at the apex at an inclination of greater than 90 degrees so that the any prescribed portion of the conical surface may be 60 degrees from vertical for example so as to be much wider than the tip portion. The spherical outer surface of the socket body is centered on the central apex of the second pivot coupling.

The socket body is generally formed of plastic material, which is integrally and seamlessly formed as a one-piece molded body with the body of the grip member 54. A metal insert 68 is inserted into the open top end of the socket body and is precisely machined to form the conical surface of the socket 66 therein.

Similarly, the tip portion 55 is a precisely machined metal pin defining the conical surface and central apex. The metal pin is set into the plastic body of the main body portion of the camera mount and the shroud portion 58 which are integrally and seamlessly molded together as a single piece.

In the balanced mode of operation, the central apexes of the first and second pivot couplings are engaged with one another at a single point contact defining the balance point of the pivot assembly. The narrower angle of the tip portion relative to the socket ensures free, unrestricted pivotal movement of the camera by deviating from the central upright axis of the second pivot coupling in any direction. By sizing the socket body to be smaller than the inner surface of the shroud portion, the socket body and shroud portion are non-contacting with one another throughout the relative pivotal movement. The generally spherical nature of the socket body and shroud portion also ensure free, uninhibited relative rotation of the camera mount relative to the grip member about the central upright axis of the pivot assembly.

The socket body is connected to a remaining portion of the grip member 54 by a stem 70 extending in the direction of the upright axis between the socket body and the grip member. The diameter of the stem portion is much less than the diameter of the bottom aperture 60 of the shroud portion, again so as not to impede relative pivoting movement between the first and second pivot couplings. The bottom aperture in the shroud portion however is smaller in diameter than the largest circumference of the socket body such that the lower portion of the shroud portion about the bottom aperture effectively defines a retainer portion which serves to retain the larger diameter socket body received within the shroud portion in a working position.

The shroud portion is defined by a plurality of independent radial sections 72, positioned in series with one another in a circumferential direction about the upright axis of the pivot assembly. Each respective section 72 is integrally molded and connected with the main body portion of the camera mount at the top end thereof to extend generally downwardly to a bottom end which defines a respective portion of the perimeter about the bottom aperture 60. An inner surface of each section 72 also defines a respective portion of the inner spherical surface of the shroud portion.

The sections are formed of resilient plastic material to permit some slight radially outward flexing of the sections which causes the overall diameter of the bottom aperture 60 to be increased sufficiently to allow removal of the spherical socket body from the shroud portion. The individual sections 72 forming the shroud portion are thus resiliently deformable from the working position to the released position in which the bottom aperture is increased in diameter sufficiently to allow removal of the socket body or to allow the socket body to be returned into the shroud portion for assembly into and subsequent use in the balanced mode of operation. Accordingly, the grip member is readily or selectively separable from the camera mount as may be desired.

The grip member 54 generally includes a grip portion 74 arranged to be gripped by the user and the second pivot coupling supported on the grip portion by the stem 70. The grip portion 74 comprises a C-shaped band of resilient material arranged to extend in a generally circumferential direction about a single finger of the user. The plastic material forming the grip portion is sufficiently stiff to grip a finger received therein in a self-supporting manner about the finger of the user so as to provide the sole support for carrying the balancing apparatus thereon in the balancing mode of operation. The gap in the generally circumferential band of material which defines the C-shape of the grip portion is located diametrically opposite from the stem 70 and permits some flexing of the material to expand the circumference of the grip portion for accommodating different size fingers therein while the opposing ends of the band of resilient material remain biased towards one another to provide a frictional gripping force about the finger.

Steering of the smart phone supported on the camera mount about an upright axis of the pivot assembly is provided by a steering member 76 which magnetically interacts with the camera mount using a first magnetic coupling 78 fixed on the camera mount and a second magnetic coupling 80 supported on the steering member. At least one of the magnetic couplings comprises a magnetic material while the other coupling comprises ferromagnetic material or a compatible magnetic material to permit magnetic attraction therebetween. The first magnetic coupling 78 is located on the camera mount adjacent the bottom side spaced from the upright axis of the balancing assembly towards a front side of the camera mount opposite the working direction of the camera. An integrally molded receptacle is formed on the main body portion of the camera mount fully below the location where the smart phone is mounted for accepting the first magnetic coupling mounted therein.

In use, the balancing apparatus is typically initially in a stored position with the stabilizer weights on the second ends of the stabilizer arms being folded together in a common plane adjacent the plane of the main body portion of the camera mount so that the stabilizer weights defined by the legs and footings thereon are wholly contained within the perimeter boundary of the camera mount. The grip member and steering member typically remain separate in storage.

When it is desired to use the device in a self-supporting standing mode of operation, the stabilizer arms are extended into the working position with the legs being adjusted in orientation relative to the support arms to accommodate the desired supporting surface upon which the apparatus is to be supported.

For subsequent use in a balanced mode of operation, the grip member is positioned on a finger of the user and the second pivot coupling is snap fit into the first pivot coupling to engage the central apexes thereof with one another. In this manner, the entire apparatus is supported on the single finger of the user received within the grip member such that a smart phone received within the camera mount is balanced at a location fully above the balance point of the pivot assembly with the counter weight provided by the legs on the second ends of the stabilizer arms spaced below the balance point.

The position of the stabilizer legs defining the stabilizer weights can be adjusted about three different axes each relative to the camera mount to achieve an optimum counterbalancing of the stabilizer weights with a phone supported on the camera mount about the balance point of the balance assembly.

As the balance assembly provides free pivotal movement of the camera mount relative to the grip member about an upright axis, the steering member is then gripped over a finger of the user in a different hand from the grip member to permit a controlled steering movement of the second hand of the user relative to the grip member on the first hand of the user resulting in a controlled steering of the working direction of the camera of the smart phone supported on the camera mount.

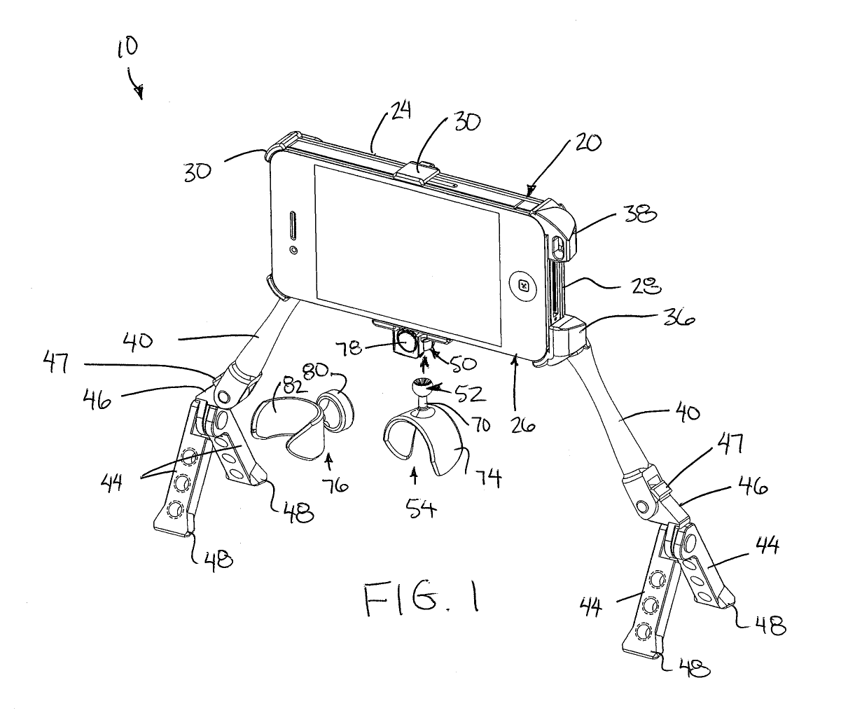

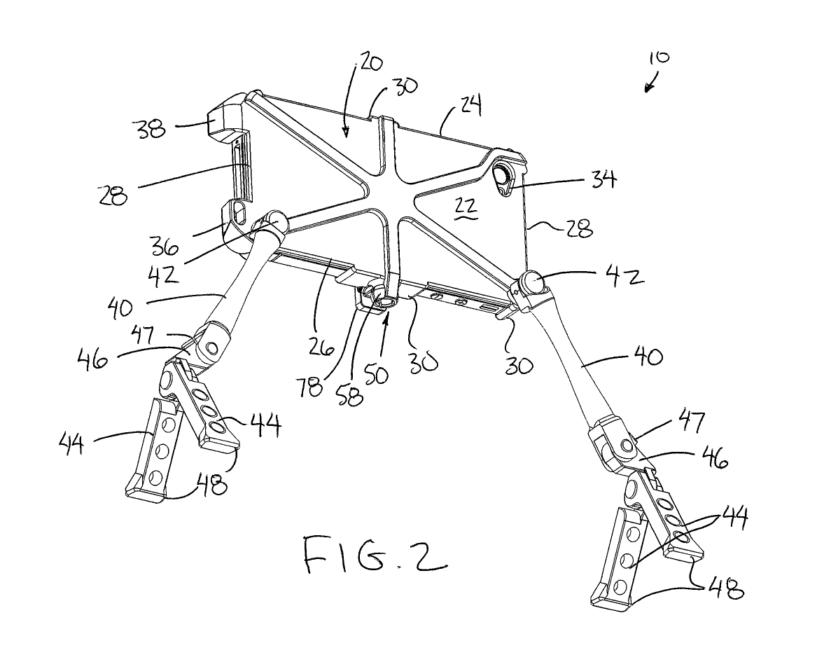

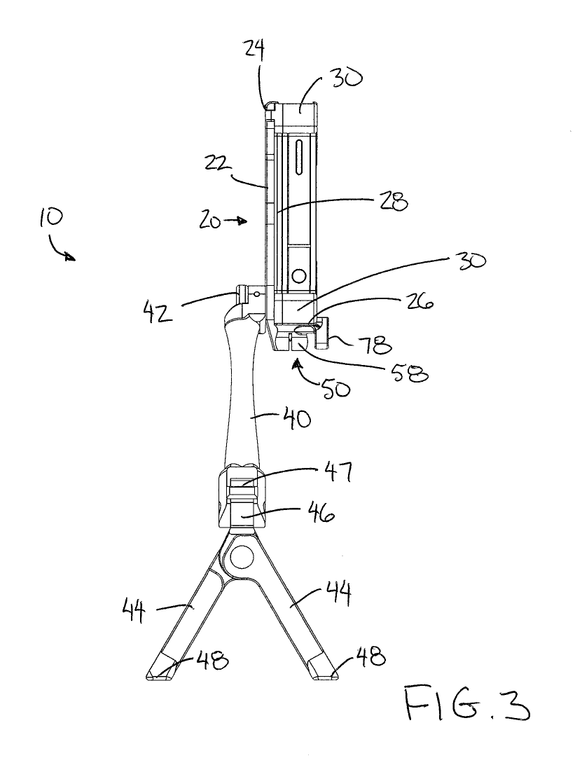

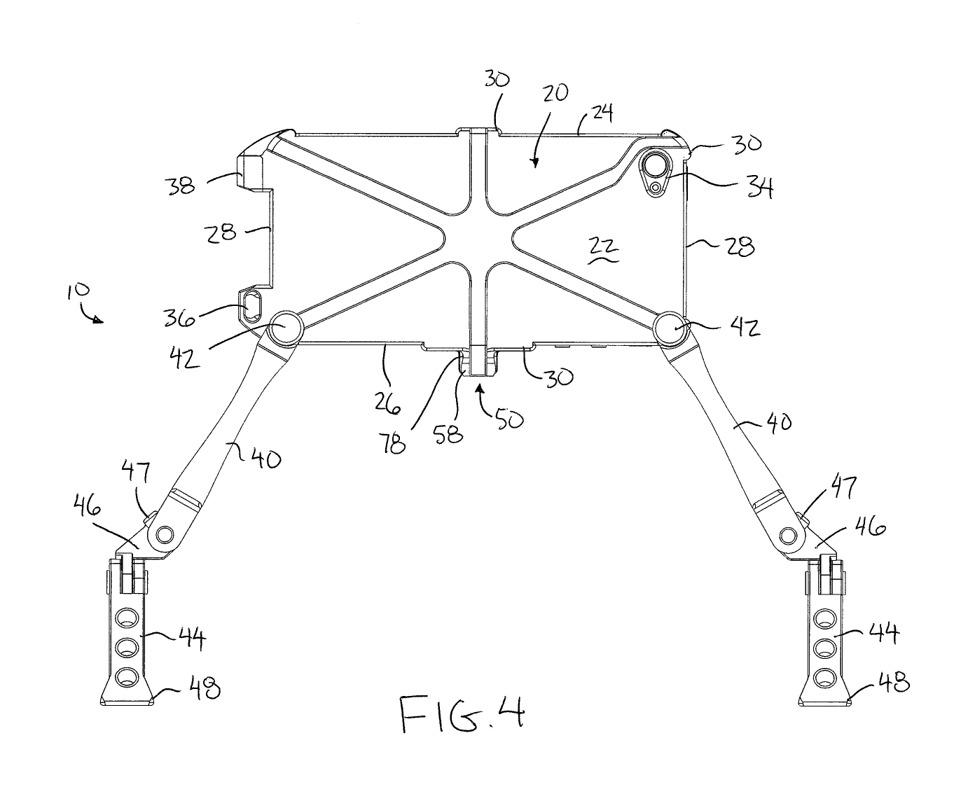

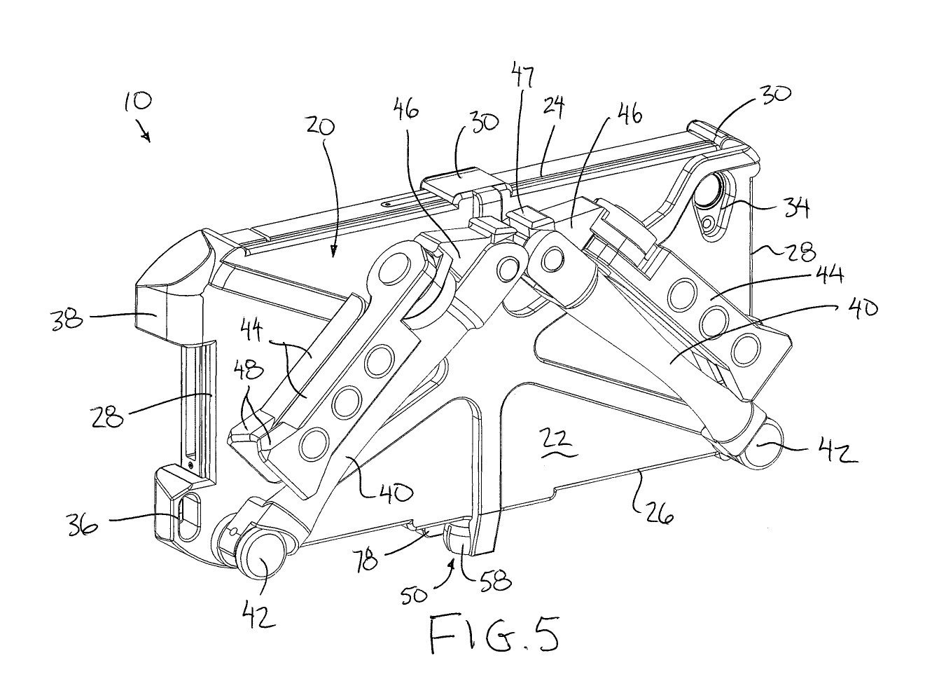

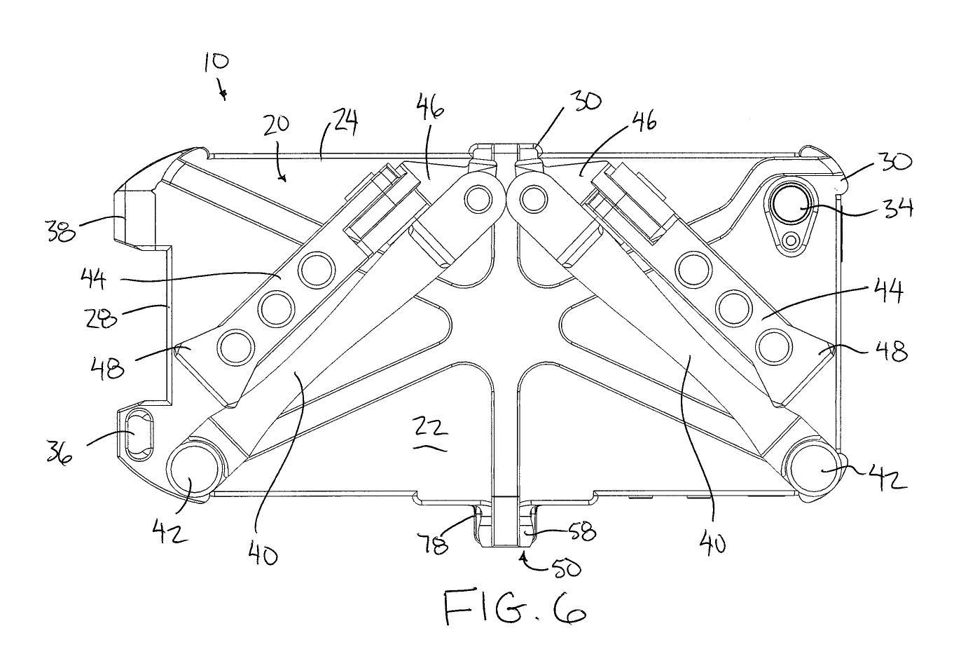

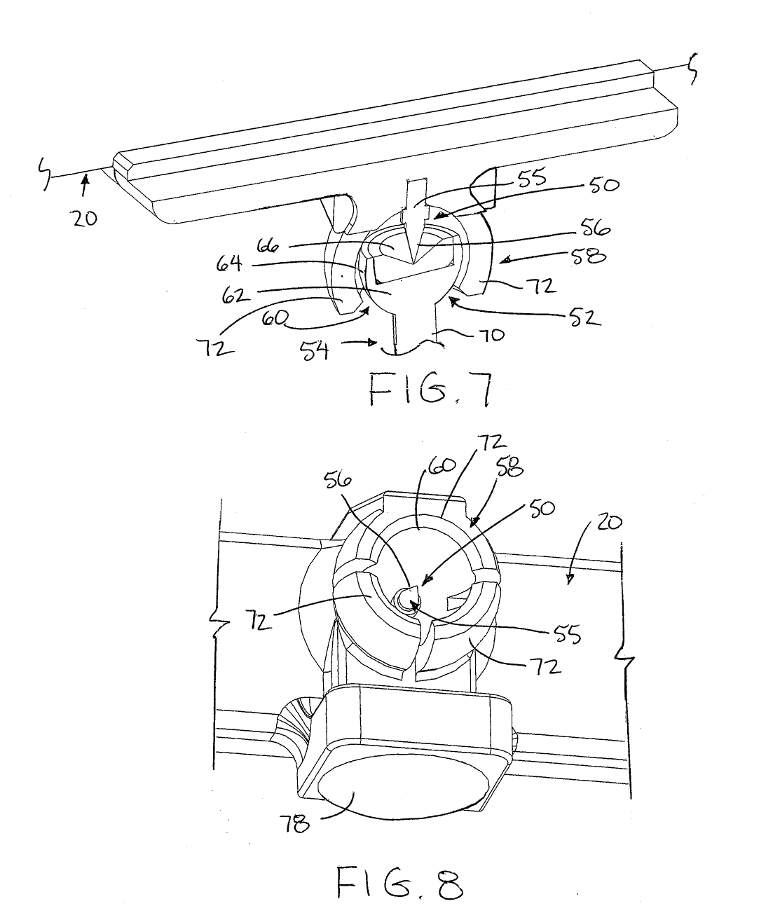

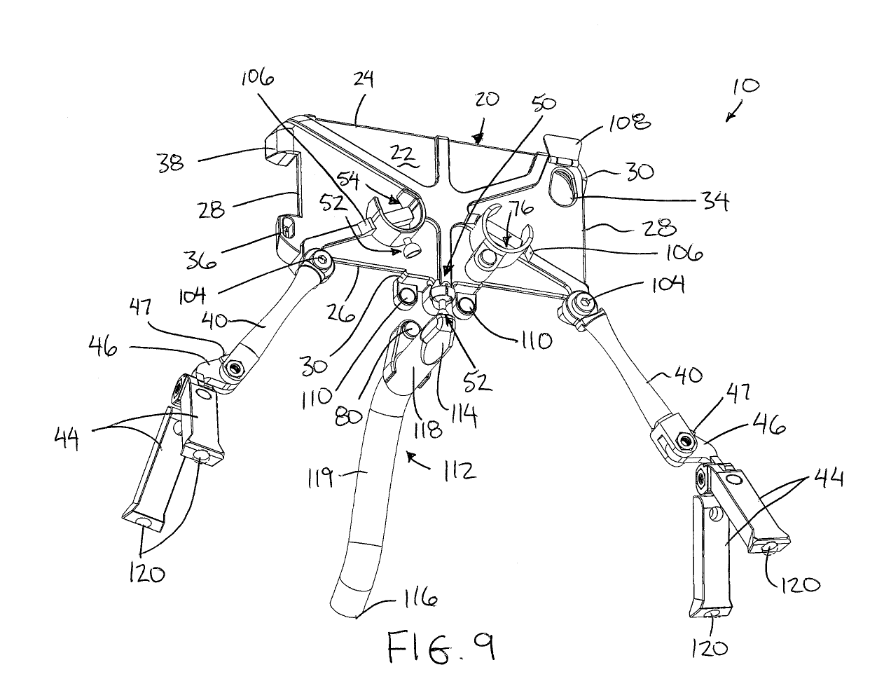

According to the first embodiment of FIGS. 1 through 8, the pivot shafts 42 are supported within the perimeter boundary defined by the rear backing member spanning the back side of the smartphone. Accordingly, when the stabilizer are pivoted into the storage position of FIG. 5, the stabilizer arms, stabilizer legs and footings are all wholly contained within the perimeter boundary. In this embodiment, the footings are formed integrally with the legs as defined by flared free ends of increased width relative to the longitudinal direction of the legs. The flared ends defining the footings 48 have flat bottoms for engaging the supporting surface in a generally rectangular configuration to one another.

Steering in the first embodiment is provided by a steering member which is independent of the grip member of the first and second pivot couplings. The steering member 76 in this instance includes a grip portion 82 which is substantially identical to the grip portion 74 noted above so as to be resiliently gripped in a self supporting manner about a single finger of the user. The second magnetic coupling is mounted within a receptacle integrally molded with the grip portion to centrally locate the magnetic coupling at a location diametrically opposite from the gap in the circumferential band of resilient material forming the grip portion. The first and second magnetic coupling members are thus arranged to interact magnetically with one another such that a non-contacting steering movement of the steering member relative to the grip member is arranged to controllably induce a similar steering movement of the camera mount relative to the grip member. Only a single magnetic coupling member is mounted on the camera mount which is magnetically attracted to the second magnetic coupling.

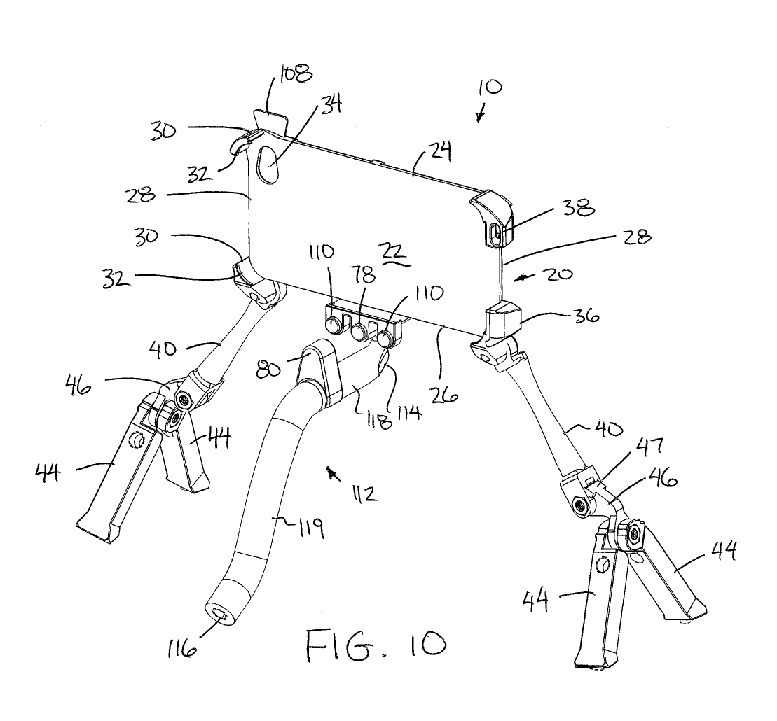

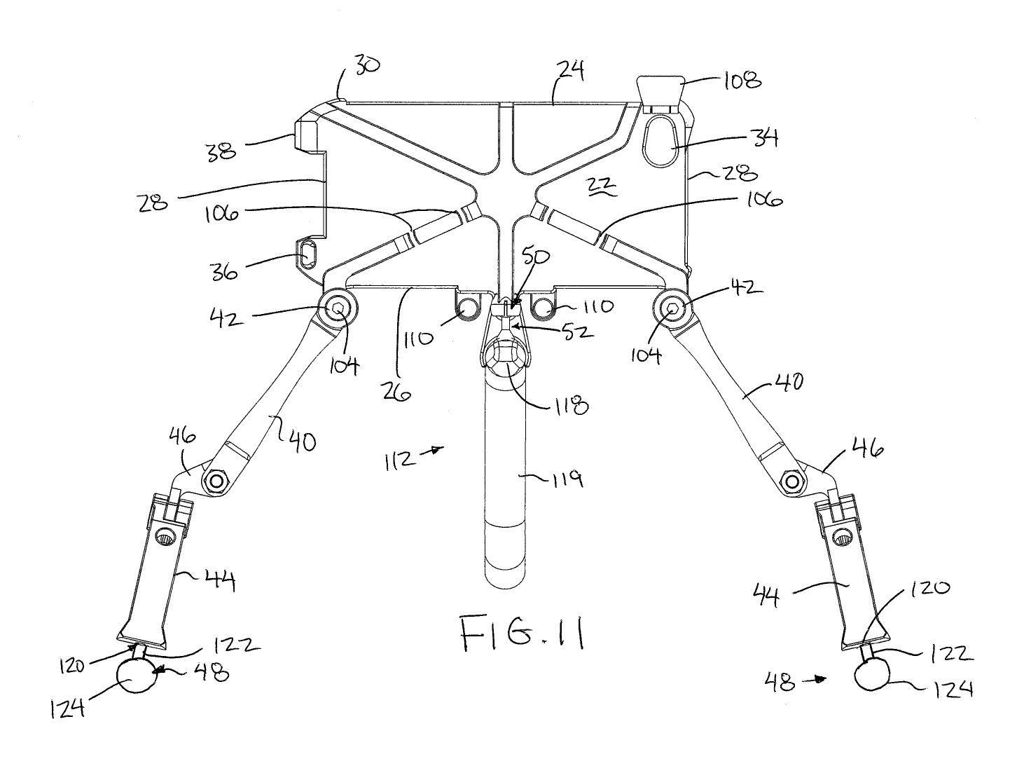

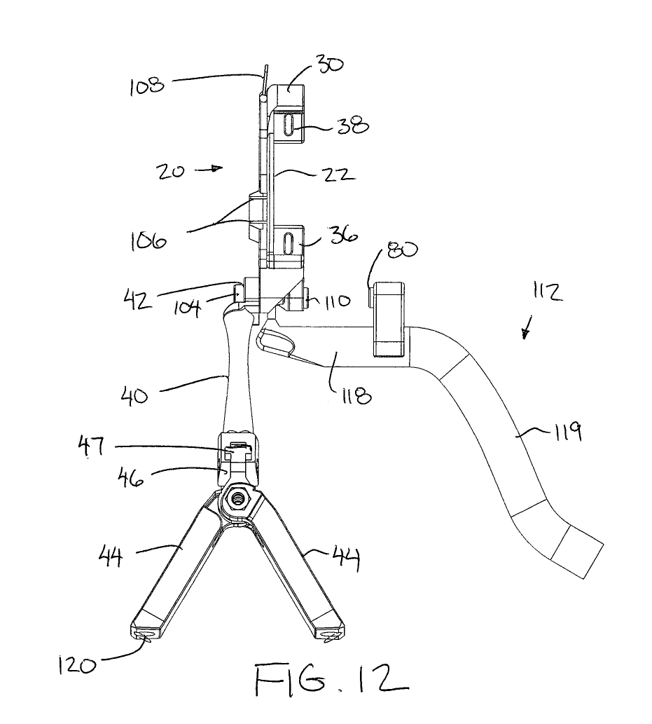

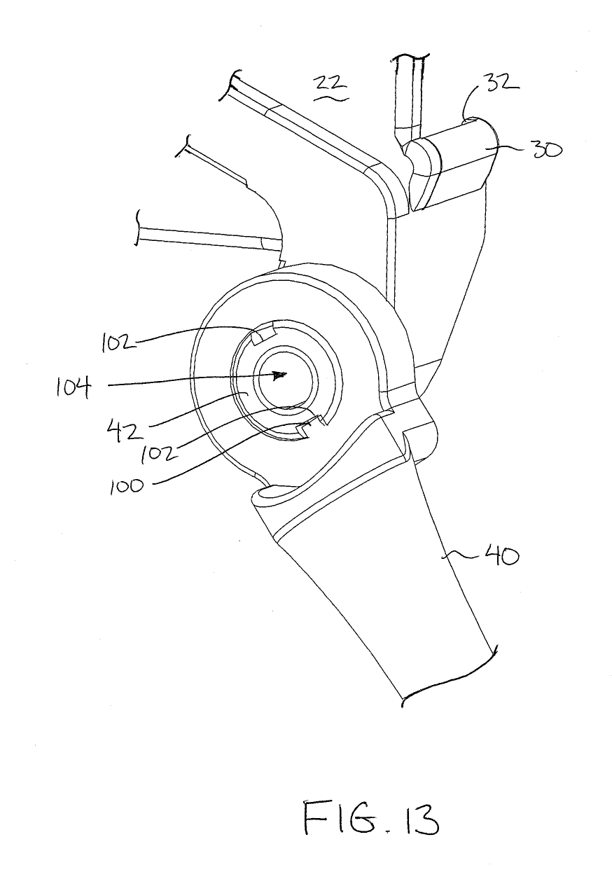

Turning now to FIGS. 9 through 13, the second embodiment of the balancing apparatus will now be described in further detail. The apparatus in this instance differs from the previous embodiment in that the pivot shafts 46 are supported on the bottom side of the camera mount such that the pivot axes thereof are spaced below the bottom edge of the main portion 22 of the camera mount so as to be positioned directly below the perimeter boundary of the camera mount. This positioning of the pivot shaft assists in lowering the center of gravity of the stabilizer arms relative to the camera and the balance point upon which the camera is balanced. The stabilizer legs remain foldable in the same manner into the storage position so that the two stabilizer arms extend upwardly and inwardly towards one another while the stabilizer legs 44 are pivoted adjacent one another to extend alongside the arms 40 respectively all in a generally common plane against the rear side of the main portion 22 of the camera mount. In this manner, substantially all of the stabilizer arms except the first end portion about the pivot shaft and all of the stabilizer legs and footings 48 thereon are fully contained within the perimeter boundary in the main portion 22 in the storage position.

The first ends of the two stabilizer arms pivotally coupled to the camera mount in this instance each comprise a collar pivotally supported about the respective pivot shaft 46. Each collar locates a locator tab 100 thereon which projects radially inward from the inner surface of the collar axially offset towards the outer end of the pivot shaft for fitting within one of two substantially diametrically opposed notches 102 formed in the pivot shaft. The locator tab of each collar permits the corresponding stabilizer arm to only be positioned in two predetermined orientations relative to the camera mount corresponding to the working position and storage position. The tabs are located on the two stabilizer arms such that the two stabilizer arms are balanced in the working position to extend downwardly and laterally outwardly away from one another at a common inclination. Similarly in the storage position, each tab is lined up with the corresponding notch so as to locate the stabilizer arms extending upwardly and inwardly towards one another.

Releasing each tab from the respective notches requires axially sliding the stabilizer arm along the pivot shaft rearwardly away from the main portion of the camera mount while a portion of the collar remains in overlapping arrangement with the pivot shaft to guide the pivotal movement thereof subsequent to releasing the tab from the respective notches. Once a tab is aligned with a corresponding notch in either the storage or working position, the tab is axially slid into the notch by abutting the stabilizer arm in the axial direction with the panel forming the main portion 22 of the camera case.

A fastener 104 is threaded into a bore in the outer end of each pivot shaft in which the head of the fastener is enlarged for overlapping the outer side of the collar about the pivot shaft to retain the collar in the axial direction. Tightening the fastener maintains the tab locked within the corresponding notch and retains the corresponding arm in the corresponding working or storage position. Loosening the fastener permits the stabilizer arm to be again axially displaced away from the main body portion of the camera mount for releasing the stabilizer arm from one of its two predetermined angular orientations for subsequent positioning in the other orientation. Fully removing the fasteners 104 allows the stabilizer arms to be fully separated from the camera mount if desired.

The main portion 22 of the camera mount also differs from the previous embodiment in that there are provided two docking formations 106 formed on the rear side of the main portion 22. Each docking formation is generally arranged as a socket for receiving a corresponding one of the two finger grips when the grip member of the balance assembly and the grip member of the steering magnets each comprise a C-shaped finger grip. The two finger grips are arranged to be centrally located in the lateral direction adjacent the bottom side of the main portion 22 of the camera mount so as not to interfere with pivoting of the stabilizer arms into the storage position when the two finger grips are stored and frictionally retained within respective sockets on the camera mount.

The camera mount of the second embodiment also differs from the previous embodiment in that there is additionally provided a light shield member 108 coupled to the main portion 22 of the camera mount at a location directly above the camera aperture to block undesirable light cast downwardly across the camera lens. The light shield member 108 comprises a flat rigid panel of material which is hinged to the main camera portion about a horizontal hinge axis above the camera aperture in which the hinge has sufficient friction to retain the shield member at whatever angular orientation it is manually positioned. In a working position, the shield member 108 projects outwardly from the plane of the main portion 22 of the camera mount. For storage, the flat panel forming the shield member can be folded flat against the main portion 22 of the camera mount so as to be parallel to the rear backing panel of a camera retained in the camera mount while spanning across the camera aperture to provide some protection to the camera lens.

The main portion 22 of the camera mount also supports two auxiliary magnetic couplings 110 immediately below the bottom side of the main portion 22 in an aligned horizontal row with the first magnetic coupling. The first magnetic coupling 78 is laterally centered between opposing sides of the camera mount in alignment with the balance point while being spaced slightly forwardly therefrom. The two auxiliary magnetic couplings 110 are laterally spaced apart equidistantly on opposing sides of the first magnetic coupling so as to be similarly located at the front side of the camera mount directly below the bottom side of a camera retained therein.

All of the magnetic couplings comprise magnets with the polarity arranged such that the first and second magnetic couplings are magnetically attracted to one another. The first magnetic coupling is magnetically repelled to each of the two auxiliary couplings 110 by an equal amount. In this manner when locating the second magnetic coupling 80 used for steering at a laterally centered location in front of the first magnetic coupling but spaced radially outward therefrom in relation to the upright steering axis, any non-contacting steering movement of the second magnetic coupling in either lateral direction about the upright steering axis involves some magnetic attraction to the first magnetic coupling to pull the camera mount with the second magnetic coupling in a steering movement about the upright steering axis of the pivot coupling relative to the second pivot coupling. Simultaneously some pushing force is provided against the auxiliary magnet coupling 110 which is offset in the same lateral direction as the steering movement to maintain the second magnetic coupling centered in the lateral direction relative to the first magnetic coupling on the camera mount.

The auxiliary magnetic couplings 110 improve the steering when using a second magnetic coupling secured to a finger grip as well as when using an alternative steering member and grip member as shown in the figures.

In the alternative steering member and grip member a common handle 112 is provided which is elongate between a first end 114 and an opposing second end 116. The second pivot coupling is mounted on the first end 114 for supporting the camera mount in a balanced configuration thereon when the opposing second end is gripped in the hand of a user and defines the gripping portion. The handle 112 also includes a main portion 118 spanning generally horizontally from the first end towards the grip portion at the second end when the second pivot coupling at the first end of the handle is oriented with its upright steering axis in a generally vertical orientation. The main portion 118 supports the second magnetic coupling 80 thereon at a location spaced radially outward from the upright steering axis of the second pivot coupling. The second magnetic coupling is supported above the handle by the same distance as the second pivot coupling such that the second pivot coupling and the second magnetic coupling are substantially in horizontal alignment with one another. The second magnetic coupling is supported on the main portion of the handle so as to be adjustable along the length of the handle to vary the radial distance between the second magnetic coupling and the balance point of the pivot assembly. In this instance, the sensitivity of the steering movement translated through the magnetic coupling can be adjusted.

The grip portion 119 of the handle extends generally at a downward and outward inclination from the main portion 118 towards the second end of the handle when the main portion is generally horizontal in orientation. The second embodiment also differs from the first embodiment in that the bottom end of each of the stabilizer legs 44 includes a threaded bore 120 formed therein so that the footing 48 in this instance includes a threaded shaft 122 arranged to be selectively received within the threaded bore so that the footing is readily separable and interchangeable with different footings of different configuration as may be desired.

A base portion 124 of the footing is located at the bottom end of the threaded shaft 122 in which the base portion may define a substantial portion of the mass of the stabilizer weight provided by the respective leg and footing combination so as to be adjustable with the leg in two different directions as described above. The footings may also be interchanged with different footing configurations having different mass or size to also affect the balance of the camera mount and a smart phone supported therein relative to the balance point of the balance assembly.

Preferably the shaft 122 and the base portion 124 and shaft 122 comprise the threaded shaft and head of a bolt respectively. A resilient pad can be secured to the outer end of the bolt head for engaging a supporting surface. Typically the bolt can be threaded into the respective leg in the range of 1.25 inches for example, however shorter or longer bolts can be interchanged to vary the stabilizing weight.

In some instances, the base portion comprises a spherical body or cylindrical body with a resilient outer surface to provide gripping to a supporting surface in various orientations and configurations as may be desired. In yet a further embodiment, the base portion 124 may comprise a wheel or roller so that the four footings collectively can be arranged for rolling movement across a supporting surface in a dolly configuration of the balance apparatus.

In yet further embodiments, the inner end of each stabilizer arm 40 mates with the respective pivot shaft 42 using a toothed pivot shaft having a plurality of splines or key at circumferentially spaced positions for interlocking with corresponding axially oriented grooves at circumferentially spaced positions along the inner surface of the collar formation at the inner end of the stabilizer arm. In this manner a retainer fastener 104 is again used to retain the stabilizer arm interlocked with the pivot shaft at a selected angular orientation in the working and stored positions, but many more angular positions are permitted. The head of the fastener 104 typically comprises a knurled thumb screw for ease of manually threading into the pivot shaft.

The other pivotal connections such as the connection of the legs 44 to the respective arms 40 may also be provided with knurled thumb screw to provide sufficient friction when tightened to retain the legs at a selected orientation relative to the arms.

In yet further embodiments, the auxiliary magnetic couplings 110 may be positioned at the same distance from the upright pivot axis of the pivot coupling assembly so that the auxiliary magnetic couplings 110 and the first magnetic coupling 78 therebetween lie along an arcuate path. The respective magnetic fields between opposing poles of each magnetic coupling thus lies along a horizontal and radial axis extending outward from the upright pivot axis of the pivot coupling assembly.

Also in further embodiments, the second magnetic coupling 80 on the steering member 76 may be oriented for magnetic interaction with the first magnetic coupling to induce a non-contacting steering movement when both the steering member 76 and the grip member 54 are supported at spaced apart positions along the same finger of the user. The second magnetic coupling 80 in this instance is spaced radially about the finger gripping portion 82 by the same height as the second pivot coupling 52 on the finger gripping portion 74 of the grip member 54 to align the first and second magnetic couplings when the first and second pivot couplings are engaged and both finger gripping portions 82 and 74 are spaced along the same finger of the user.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A balancing apparatus for a handheld camera device comprising:
a camera mount arranged to support the handheld camera device in fixed relation thereon;
a first pivot coupling supported on the camera mount such that the camera mount is arranged to support the handheld camera device substantially above the first pivot coupling;
at least one stabilizer arm extending between a first end coupled to the camera mount and a second end supporting a stabilizing weight thereon below the first pivot coupling; and
a grip member comprising a grip portion arranged to be gripped by a user and a second pivot coupling supported on the grip portion;
the second pivot coupling being arranged to be coupled to the first pivot coupling for pivotal movement relative to one another about a balance point between the first and second pivot couplings such that the stabilizing weight of said at least one stabilizer arm is arranged to be balanced below the balance point with the camera mount above the balance point when a handheld camera device is supported on the camera mount; and
the grip portion of the grip member comprising a finger grip arranged to be gripped in a self-supporting manner about at least one finger of a user such that the balancing apparatus is arranged to be carried solely on said at least one finger of the user.

2. The apparatus according to claim 1 wherein the finger grip comprises a C-shaped member arranged to extend generally circumferentially about a single finger of the user.

3. The apparatus according to claim 2 wherein the C-shaped member is formed of resilient material arranged to resilient grip said single finger of the user therein.

4. The apparatus according to claim 1 wherein:
one of the first and second pivot couplings comprises a socket body locating a socket therein having an inner surface which tapers radially inwardly and axially inwardly towards a central apex of the socket;
the other one of the first and second pivot couplings comprises:
a tip portion projecting axially outwardly and tapering radially inwardly towards a central apex which is pointed and which is engaged with the central apex of the socket at the balance point so as to be arranged for pivotal movement relative to one another; and
a shroud portion in fixed relation to the tip portion which at least partially surrounds the socket body.

5. The apparatus according to claim 4 wherein the shroud portion is in non-contacting relationship with the socket body when the central apex of the tip portion is engaged with the central apex of the socket and the camera mount is balanced above the balance point with the stabilizing weight of said at least one stabilizer arm below the balance point.

6. The apparatus according to claim 4 wherein the shroud portion includes a retainer portion arranged to retain the socket body within the shroud portion such that the central apex of the tip portion remains engaged with the central apex of the socket in a working position.

7. The apparatus according to claim 6 wherein the retainer portion is resiliently deformable from the working position to a release position in which the socket body is readily removable from the shroud portion

8. The apparatus according to claim 4 wherein the shroud portion comprises plastic material which is integrally formed with the camera mount, the central apex of the tip portion is formed of metal and is mounted in fixed relation to the camera mount with the shroud portion, and the central apex of the socket is formed of metal and is mounted in fixed relation with the grip member.

9. The apparatus according to claim 1 further comprising:
a first magnetic coupling member on the camera mount;
a steering member separate from the camera mount, the steering member including a grip portion arranged to be gripped by a user and a second magnetic coupling member supported on the grip portion;
the first and second magnetic coupling members being arranged to interact magnetically with one another such that a non-contacting steering movement of the steering member relative to the grip member is arranged to controllably induce a steering movement of the camera mount relative to the grip member;
wherein the grip portion of the steering member comprising a finger grip arranged to be gripped generally circumferentially about a single finger of the user.

10. The apparatus according to claim 1 wherein the camera mount comprises a smartphone case arranged to receive a video camera enabled smartphone therein, the first pivot coupling being integrally formed on the smartphone case.

11. The apparatus according to claim 10 wherein the camera mount further comprises:
a rear backing member arranged to span a rear side of a smartphone therein;
a camera aperture in the rear backing member arranged to align with a camera of the smartphone; and
a light shield member arranged to protrude rearwardly from the rear backing member above the camera aperture in a working position.

12. The apparatus according to claim 1 wherein the stabilizing weight of said at least one stabilizer arm is supported by a first mounting portion so as to be adjustable in a lateral direction relative to the camera mount and by a second mounting portion so as to be adjustable in the forward direction relative to the camera mount.

13. The apparatus according to claim 12 wherein:
the stabilizer weight of said at least one stabilizer arm is supported by the first mounting portion for pivotal movement relative to the camera mount about a first axis oriented in a forward direction of the handheld camera device and by the second mounting portion for pivotal movement relative to the camera mount about a second axis oriented in the lateral direction of the handheld camera device;
both the first axis and the second axis are located in proximity to the second end of the stabilizer arm; and
said at least one stabilizer arm is pivotal relative to the camera mount about an auxiliary axis which is located at the first end of the stabilizer arm and which is substantially parallel with the first axis.

14. The apparatus according to claim 1 wherein said at least one stabilizer arm comprises two stabilizer arms coupled to the camera mount at laterally spaced positions, each for respective movement between a stored position in which the stabilizing weights and stabilizer arms are supported in a generally common plane with one another adjacent the camera mount and at least one working portion in which the stabilizing weight is spaced below the camera mount at a predefined position.

15. The apparatus according to claim 1 wherein said at least one stabilizer arm comprises two stabilizer arms arranged to be coupled to the camera mount in a working position, each stabilizer arm supporting two stabilizer weights thereon such that each stabilizer weight is adjustable both in a lateral direction relative to the camera mount and in the forward direction relative to the camera mount.

16. The apparatus according to claim 15 wherein each of the four stabilizer weights comprises a footing supported thereon so as to be readily interchangeable with another footing of different configuration, and wherein the camera mount is arranged to be self-supported in an upright orientation on a generally horizontal supporting surface when only the footings are engaged with the supporting surface.

17. A balancing apparatus for a handheld camera device comprising:
a camera mount arranged to support the handheld camera device in fixed relation thereon;
a first pivot coupling supported on the camera mount such that the camera mount is arranged to support the handheld camera device substantially above the first pivot coupling;
at least one stabilizer arm extending between a first end coupled to the camera mount and a second end supporting a stabilizing weight thereon below the first pivot coupling; and
a grip member comprising a grip portion arranged to be gripped by a user and a second pivot coupling supported on the grip portion;
wherein the second pivot coupling is arranged to be coupled to the first pivot coupling for pivotal movement relative to one another about a balance point between the first and second pivot couplings such that the stabilizing weight of said at least one stabilizer arm is arranged to be balanced below the balance point with the camera mount above the balance point when a handheld camera device is supported on the camera mount;
wherein one of the first and second pivot couplings comprises a socket body locating a socket therein having an inner surface which tapers radially inwardly and axially inwardly towards a central apex of the socket; and
wherein the other one of the first and second pivot couplings comprises:
a tip portion projecting axially outwardly and tapering radially inwardly towards a central apex which is pointed and which is engaged with the central apex of the socket at the balance point so as to be arranged for pivotal movement relative to one another; and
a shroud portion in fixed relation to the tip portion which at least partially surrounds the socket body.

18. The apparatus according to claim 17 further comprising:
a first magnetic coupling member supported on the camera mount;
a second magnetic coupling member arranged to be magnetically attracted to the first magnetic coupling member such that a non-contacting steering movement of the second magnetic coupling member relative to the grip member about an upright steering axis is arranged to controllably induce a corresponding steering movement of the camera mount relative to the grip member about the upright steering axis; and
a pair of auxiliary magnetic members supported on the camera mount at laterally opposing sides of the first magnetic coupling member, the auxiliary magnetic members being arranged to be magnetically repelled by the second magnetic coupling member such that the second magnetic coupling member is arranged to remain substantially laterally balanced between the pair of auxiliary magnetic members at a location spaced outwardly from the upright steering axis during said non-contacting steering movement.

19. The apparatus according to claim 17 further comprising:
a first magnetic coupling member supported on the camera mount;
a second magnetic coupling member supported on the grip member at a location spaced radially outwardly from an upright steering axis of the pivot couplings;
the second magnetic coupling member being arranged to magnetically interact with the first magnetic coupling member such that a non-contacting steering movement of the second magnetic coupling member relative to the grip member about the upright steering axis is arranged to controllably induce a corresponding steering movement of the camera mount relative to the grip member about the upright steering axis.

20. A balancing apparatus for use with a smartphone including a rear backing plate and a video camera, the apparatus comprising:
a camera mount arranged to support the handheld camera device in fixed relation thereon;
a first pivot coupling supported on the camera mount such that the camera mount is arranged to support the handheld camera device substantially above the first pivot coupling;
at least one stabilizer arm extending between a first end coupled to the camera mount and a second end supporting a stabilizing weight thereon below the first pivot coupling; and
a grip member comprising a grip portion arranged to be gripped by a user and a second pivot coupling supported on the grip portion;
the second pivot coupling being arranged to be coupled to the first pivot coupling for pivotal movement relative to one another about a balance point between the first and second pivot couplings such that the stabilizing weight of said at least one stabilizer arm is arranged to be balanced below the balance point with the camera mount above the balance point when a handheld camera device is supported on the camera mount;
wherein the stabilizing weight of said at least one stabilizer arm is supported by a first mounting portion so as to be adjustable in a lateral direction relative to the camera mount and by a second mounting portion so as to be adjustable in the forward direction relative to the camera mount.
